(19) United States
(12) Patent Application Publication
(10) Pub. No.: US 2009/0321588 A1
(43) Pub. Date: Dec. 31, 2009

(54) Mounting clamp

(76) Inventor: Kevin A. Sullivan, Arnold, MO (US)

Correspondence Address: DOUGLAS E. WARREN;ATTORNEY AT LAW, P.O. BOX 6727, CHESTERFIELD, MO, 63006, US

(21) Appl. No.: 12/215,240

(22) Filed: Jun. 26, 2008

(51) Int. Cl. F16L 3/00

(52) U.S. Cl. 248/74.2; 248/74.3; 248/49

(57) ABSTRACT

The present invention relates to a mounting clamp that does not use threaded fasteners to close the mounting clamp to retain electrical conduit, plumbing pipe, or other construction components within the mounting clamp.

### CROSS REFERENCE TO RELATED APPLICATIONS

Not applicable.

### STATEMENT REGARDING FEDERALLY SPONSORED RESEARCH

Not Applicable.

### BACKGROUND OF THE INVENTION

In the construction industry, a wide variety of construction components are attached to a number of mounting surfaces. For example, plumbing components are often mounted to ceilings and walls of both residential and commercial buildings. Additionally electrical conductors are used extensively throughout virtually every commercial or residential building.

With regard to the mounting of electrical conductors, in most cases, the electrical codes of the local building authorities require that all electrical conductors be sufficiently hidden and protected from situations that might damage the electrical conductors. This safety requirement usually means most electrical conductors must be disposed within various types of electrical conduit for electrical conductors. This can include electrical conduit that is made from plastic and metal.

When electrical conduit is installed, it is not simply attached directly to the walls or ceilings of the commercial or residential building. Instead, the electrical code normally mandates the use of electrical conduit mounting clamps. The electrical conduit mounting clamps are installed onto the surfaces of the walls or ceilings and then the electrical conduit is installed within the electrical conduit mounting clamps.

The most common electrical conduit mounting clamp is generally circular in shape to match the circular shape of the electrical conduit. The circular shape of the electrical conduit mounting clamp has one portion of the circular shape open to allow the electrical conduit to be inserted into the electrical conduit mounting clamp. The open portion of the electrical conduit mounting clamp has flanges through which fasteners such as screws, washers, and nuts are disposed. These fasteners are tightened after the electrical conduit has been installed within the circular shape of the electrical conduit mounting clamp to keep the electrical conduit in place.

Although this is the most common type of electrical conduit mounting clamp used today, that type of clamp substantially increases the cost of installing electrical conduit mounting clamps and electrical conduit. This cost increase results from the labor intensive efforts needed to install the electrical conduit into the electrical conduit mounting clamp. More specifically, that process requires that the fasteners installed within the electrical conduit mounting clamp be removed to allow the electrical conduit to be inserted into the circular portion of the electrical conduit mounting clamp, the electrical conduit must then be inserted into the circular portion of the electrical conduit mounting clamp, the fasteners must be reinstalled into the flanges of the electrical conduit mounting clamp, and finally the fasteners must be tightened to ensure that the electrical conduit is properly captivated within the electrical conduit mounting clamp. Each of these steps include significant amounts of labor and the labor costs for installing electrical conductors within electrical conduit that are held in place on the walls and ceilings of buildings by electrical conduit mounting clamps can very often be higher than the cost of the electrical components themselves. Additionally, most current electrical conduit mounting clamps are not of one-piece construction. In that configuration, the handling and sometimes simultaneous installation of the fasteners used to tighten the clamping mechanism add further labor cost.

With regard to plumbing components, virtually all of the above comments regarding the mounting of electrical components are similarly applicable to the mounting of plumbing components. In fact, when any type of construction component is mounted to a surface, the type of component mounting device as described above suffers from the same disadvantages noted above.

### SUMMARY OF THE INVENTION

The various embodiments of the present invention include configurations of a mounting clamp that can hold electrical conduit, plumbing pipes, and other construction components into position, but without the use of fasteners that must be removed and then reinstalled to mount the construction component within the mounting clamp. In alternative embodiments of the invention, the clamp and the mounting base are made in a substantially integrated one-piece unit.

### DESCRIPTION OF THE DRAWINGS

In the accompanying drawings which form part of the specification:

FIG. 1 is a front view of one embodiment of the present invention;

FIG. 2 is a side view of one embodiment of the present invention;

FIG. 3 is a side view of one embodiment of the present invention after installation into a common mounting channel;

FIG. 4 is a top view of one embodiment of the present invention after installation into a common mounting channel;

FIG. 5 is a perspective view of one embodiment of the present invention showing how that embodiment is installed into a common mounting channel;

FIG. 6 is a front view of an alternative embodiment of the present invention showing a different type of clamping mechanism in its closed position;

FIG. 7 is a side view of an alternative embodiment of the present invention showing a different type of clamping mechanism; and

FIG. 8 is a front view of an alternative embodiment of the present invention showing a different type of clamping mechanism in its open position.

Corresponding reference characters indicate corresponding parts throughout the several views of the drawings.

While embodiments of the present invention are illustrated in the above referenced drawings and in the following descriptions, it is understood that the embodiments shown are merely for purpose of illustration and that various changes in construction may be resorted to in the course of manufacture in order that the present invention may be utilized to circumstances which may arise, without in any way departing from the spirit and intention of the present invention, which is to be limited only in accordance with the claims contained herein.

### DETAILED DESCRIPTION OF ONE PREFERRED EMBODIMENT

The present invention relates to a mounting clamp A used as part of the set of components used to mount construction components to the walls or ceilings of commercial and residential buildings. It is understood that the term “construction component” as used herein may be construed to mean plumbing pipes, electrical conduit, or any other construction component that utilizes mounting clamps that tend to clamp the surfaces of the construction component being mounted to a mounting surface to thereby mount the construction component into a generally fixed position.

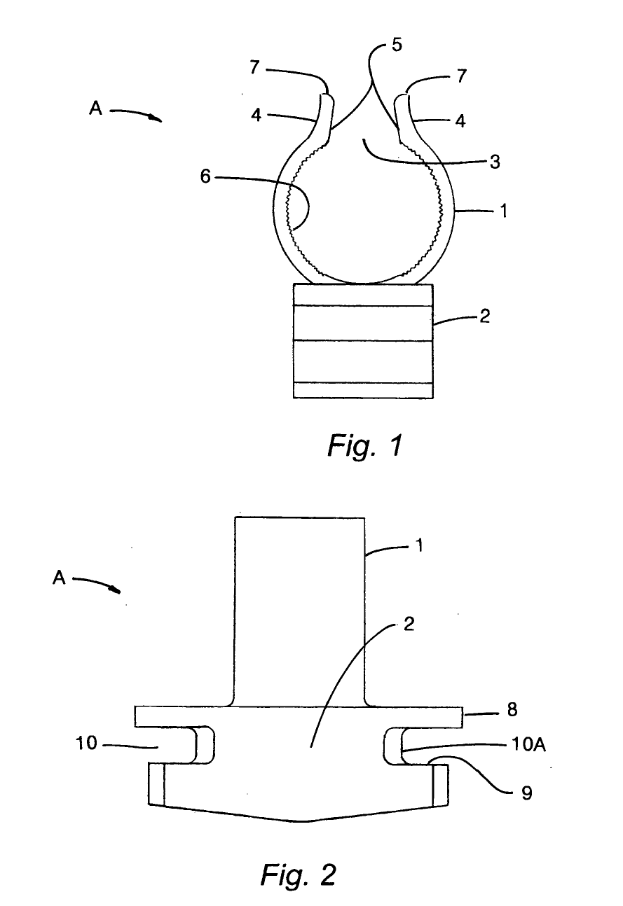

Referring to FIG. 1 and FIG. 2, the mounting clamp A includes a clamp 1 and a mounting base 2. In this embodiment, the clamp 1 and the mounting base can be made as a substantially integral one-piece unit with the clamp 1 being substantially circular and including an open portion 3 that interrupts the generally arcuate shape of the clamp. The open portion 3 has two flanges 4 that can be generally parallel. Each of the flanges 4 may have a rounded end 7 and a surface 5. In one embodiment of the present invention, the inside surface 6 of the clamp 1 is not smooth. Instead, the inside surface 6 has a non-flat texture throughout the arcuate portions of the clamp 1. In alternative embodiments, the inside surface of the clamp 1 is smooth and does not have a textured surface. The inside diameter of the clamp 1 can be of any size, but the inside diameter of the clamp in any single embodiment is sized to allow standard sizes of commonly used electrical conduit, plumbing pipe, or any other construction component to be inserted in the clamp. Likewise, the opening 3 can also be of any size, but the size of the opening in any single embodiment is sized to allow standard sizes of commonly used electrical conduit, plumbing pipe, or other construction component to be sufficiently smaller than the dimension of commonly used sizes of those items.

It is appreciated that a substantial portion of the clamping action of the clamp 1 is achieved by the general shape of the clamp 1. That is to say, the circular shape of the clamp 1 and the tendency of the material used to make the mounting clamp A to resist deformation of the clamp, work in partnership to assist the clamp in grasping the construction component into the clamp. Additionally, these characteristics encourage the construction component to resist any action that would tend to allow the construction component to be removed from the clamp.

More specifically, in the present embodiment, the opening 3 between the two flanges 4 should be sized to allow the construction component to be inserted through the opening 3 and into the inside of the clamp 1, while still sizing the opening to be sufficiently small enough to impede the construction component from being easily withdrawn from the clamp by moving the construction component through the opening 3 of the clamp 1. In a preferred embodiment wherein the mounting clamp A is made from a flexible material, the size of the opening should be large enough to allow the insertion of the selected construction component to pass through the opening 3 without the flexible material being substantially deformed, but small enough to substantially captivate the construction component within the clamp 1 by impeding the construction component from being easily withdrawn from the clamp 1. Thus, in each preferred embodiment of the mounting clamp A, there should be some amount of dimensional interference between the size of the dimension of the construction component being inserted into the clamp 1 and the size of the opening 3 between the two flanges 4. The actual amount of the dimensional interference between the dimension of the construction component used for the opening 3 may be adjusted as necessary to functionally accommodate the material from which the mounting clamp A is made while still impeding the construction component from easily passing through the opening 3.

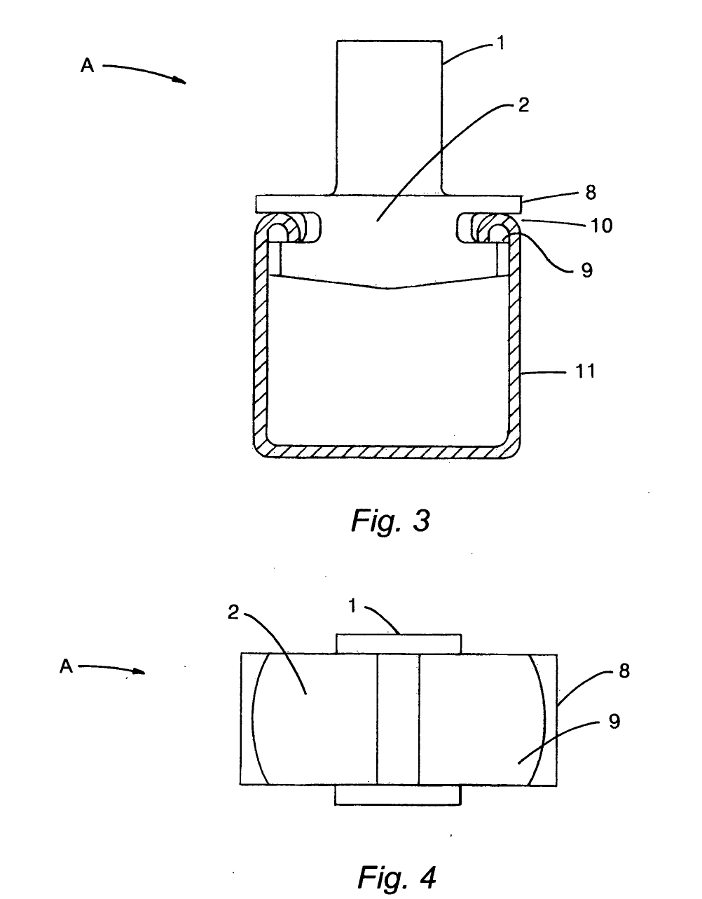

Referring now to FIG. 2, the mounting base 2 includes an upper flange 8, a lower flange 9, and a channel opening 10 disposed between the upper flange and the lower flange. FIG. 3 shows the general interrelationship between the upper flange 8, the lower flange 9, and the channel opening 10. More specifically, it is noted that within the construction industry a common method of mounting a construction component mounting clamp to a surface includes the installation of a mounting channel 11 to the surface. One type of mounting channel is known as UNISTRUT® which is the mounting channel of choice for most construction projects.

In recognition of that fact, a preferred embodiment of the mounting clamp A is generally configured to be installed into the UNISTRUT® channel shape. Thus, FIG. 3 shows that the size, location, and shape of the upper flange 8, the lower flange 9, and the channel opening 10 of a preferred embodiment will be determined as required to allow the mounting clamp A to be installed into the UNISTRUT® shape as shown in FIG. 3. It is understood that the final size, location, and shape for the upper flange 8, the lower flange 9, and the channel opening 10 in a preferred embodiment will allow the mounting clamp A to be slideably inserted and installed as shown in FIG. 3 into the UNISTRUT® shape. Nevertheless, it will be appreciated by those of skill in the art that the size, location, and shape for the upper flange 8, the lower flange 9, and the channel opening 10 can all be adjusted to fit any mounting channel or mounting shape into which the mounting clamp A maybe slideably inserted and installed. It is also noted that in alternative preferred embodiments, the lower flange 9 and the surface 10A have a generally arcuate shape. In a preferred embodiment, these arcuate shapes allow the mounting clamp A to be more easily installed into a UNISTRUT® mounting channel.

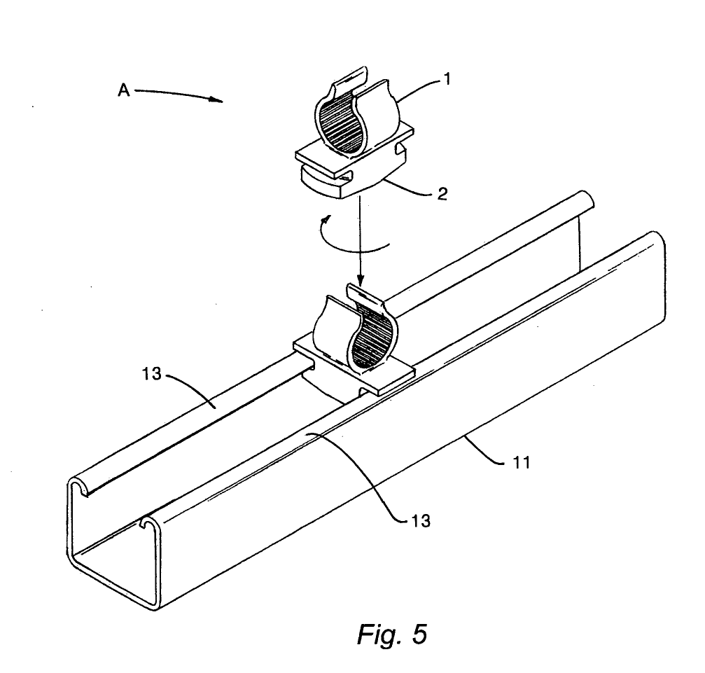

More specifically, FIG. 5 shows one alternative method of installing one embodiment of the mounting clamp A into the mounting channel. This type of installation requires the mounting clamp A to be initially positioned such that the longitudinal axis of the inside diameter of the clamp 1 be located generally parallel to the longitudinal axis of the mounting channel 11. The mounting clamp A is then lowered into the mounting channel 11 until the channel opening 10 is in general alignment with the upper legs 13 of the mounting channel 11. Then, the mounting clamp A is rotated about 90 degrees until the longitudinal axis of the inside diameter of the clamp 1 becomes substantially perpendicular to the longitudinal axis of the mounting channel 11. It is understood that when the mounting clamp A is thus rotated that upper flanges 8 and the lower flanges 9 of the mounting base 2 of the mounting clamp substantially captivate the upper legs 13 of the mounting channel 11 within the channel opening 10 of the mounting base. The lower flanges 9 of the mounting base 2 may have rounded edges to allow the mounting base to be rotated within the mounting channel 11 without substantial interference between the lower flanges 9 and the inside walls of the mounting channel 11.

Upon the installation of the mounting clamp A into the mounting channel as described above, the mounting clamp A is ready to accept the installation of a portion of the construction component into the clamp 1. It is noted that in a preferred embodiment of the present invention the portion of the construction component will have its longitudinal axis generally aligned with the longitudinal axis of the inside diameter of the clamp 1, while also having its longitudinal axis generally perpendicular with the mounting channel 11. In the present embodiment, the construction component is held in place within the mounting clamp A by the clamping action of the clamp 1 around the construction component and by the interference dimension between the dimension of the construction component and the size of the opening 3 between the flanges 4 of the clamp 1.

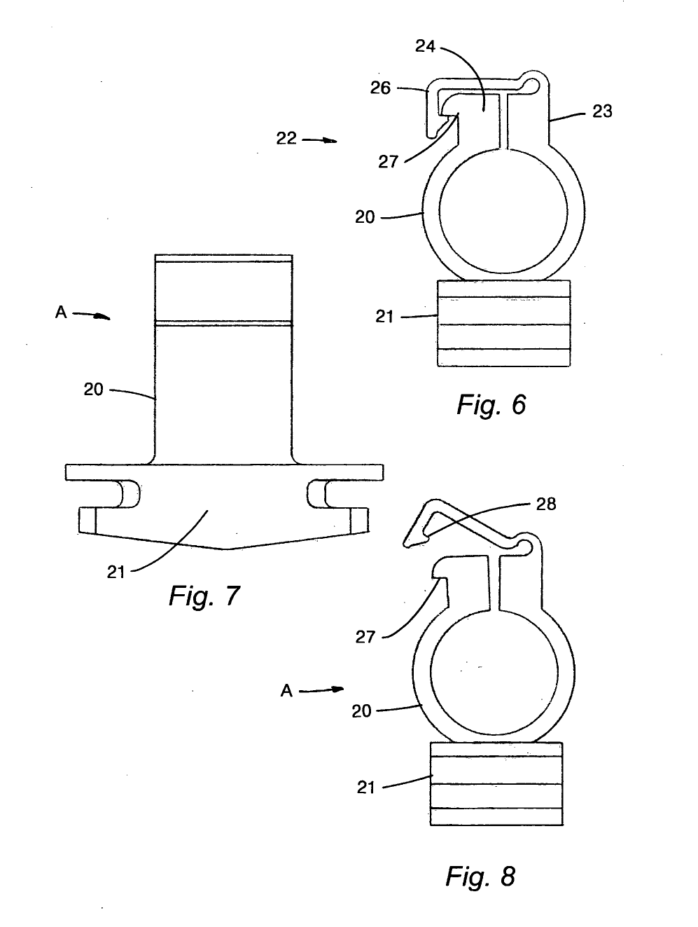

Another alternative embodiment of the present invention is shown in FIG. 6, FIG. 7, and FIG. 8. In that embodiment, the clamp portion of the mounting clamp A has an alternative configuration for impeding the construction component from exiting the clamp portion. More specifically, in FIG. 6 the clamp 20 of the mounting clamp A does not include the two flanges 4 of the embodiment shown in FIG. 1 through FIG. 5 and does not rely as much upon the resistance to deformation of the material used to make the mounting clamp A to encourage the construction component to remain within the clamp. Instead, the clamp 20 incorporates a locking mechanism 22 that biases the clamp ends together to thus assist in the retention of the construction component within the mounting clamp A.

The locking mechanism 22 includes a first clamp end 23, a second clamp end 24, a latch 26, and a catch 27. In this embodiment, the catch 26 is operatively connected to the first clamp end 23. Additionally, the catch 27 is disposed in connection with the second clamp end 24. The remainder of the other elements of this alternative embodiment are similar to the related elements as described in FIG. 1 through FIG. 5.

In operation, the latch 26 of the present alternative embodiment is disengaged from the catch 27 and the latch is then lifted away from the clamp 20 enough to allow the construction component to be moved through the gap 25. When the construction component has moved through the gap 25 and into the inside area of the clamp 20, the latch 26 is positioned over the first clamp end 23 and the second clamp end 24 with the construction component now positioned inside the clamp 20. The latch 26 is adjusted until it engages with the catch 27 to thereby essentially close the clamp 20. Although the present configuration shows the latch 26 using a protrusion 28 (FIG. 8) to operatively engage with the catch 27 to lock the locking mechanism 22, it will be understood by those of skill in the art that other types of locking configurations may be used to generate a locking mechanism while still remaining with the intended scope of preferred embodiments of the present invention. For example, the locking mechanism may incorporate any interlocking configuration such as matching sets of serrated teeth, male/female interlocks, or buckles as long as the interlocking configuration does not include the use of fasteners such as screws, threaded rods, or rivets to retain the ends of the clamp together.

While the above description describes various embodiments of the present invention, it will be clear that the present invention may be otherwise easily adapted to fit any configuration where a mounting clamp is required. Additionally, as various changes could be made in the above constructions without departing from the scope of the invention, it is also intended that all matter contained in the above description or shown in the accompanying drawings shall be interpreted as illustrative and not in a limiting sense. The scope of the invention should be determined by the appended claims and their legal equivalents, rather than by the examples given.

What is claimed is:

1. A mounting clamp comprising:
a clamp having at least two opposing elements that are biased toward each other such that two opposing elements will tend to retain a portion of a construction component that has been disposed within the clamp; and
a mounting base upon which the clamp is disposed.

2. The mounting clamp of claim 1 wherein the clamp is substantially circular and includes an open portion that interrupts the generally arcuate shape of the clamp wherein the at least two opposing elements are generally located near the open portion, and wherein the clamp and the mounting base are made as a substantially single integrated component.

3. The mounting clamp of claim 2 wherein the at least two opposing elements are at least two flanges that are generally parallel.

4. The mounting clamp of claim 3 wherein each of the at least two flanges have a rounded end and wherein the clamp has an inside surface that is not smooth.

5. The mounting clamp of claim 4 wherein the inside diameter of the clamp is sized to allow standard sizes of commonly used within at least one of either electrical conduit, plumbing pipe, or other construction component to be inserted in the clamp.

6. The mounting clamp of claim 5 wherein a portion of the clamping action of the clamp is achieved by the tendency of the material used to make the mounting clamp to resist deformation of the clamp.

7. The mounting clamp of claim 6 further comprising an opening between the at least two flanges wherein the opening is sized to allow the construction component to be inserted through the opening and into the clamp while still being sized sufficiently small enough to impede the construction component from being easily withdrawn from the clamp by moving the construction component through the opening.

8. The mounting clamp of claim 7 wherein the mounting clamp is made from a flexible material such that the size of the opening will be large enough to allow the insertion of the portion of the construction component to pass through the opening without the flexible material being substantially or permanently deformed, while still keeping the opening small enough to substantially captivate the construction component within the clamp by impeding the construction component from being easily withdrawn from the clamp.

9. The mounting clamp of claim 8 wherein the mounting base includes an upper flange, a lower flange, and a channel opening disposed between the upper flange and the lower flange.

10. The mounting clamp of claim 9 wherein the lower flange of the mounting base has an arcuate edge.

11. The mounting clamp of claim 2 wherein the clamp is substantially circular and includes an open portion that interrupts the generally arcuate shape of the clamp and wherein the opening has a clamping mechanism that impedes the portion of the construction component from exiting the clamp portion.

12. The mounting clamp of claim 11 wherein the clamping mechanism incorporates a locking mechanism that biases ends of the clamp together to assist in the retention of the construction component within the clamp.

13. The mounting clamp of claim 12 wherein the locking mechanism includes a first clamp end, a second clamp end, a latch, and a catch.

14. The mounting clamp of claim 13 wherein the catch is operatively connected to the first clamp end and the catch is disposed in connection with the second clamp end such that when the locking mechanism can be configured in a locked position tending to retain the portion of the construction component within the clamp.

15. The mounting clamp of claim 14 wherein when the latch is disengaged from the catch and the latch is then lifted away from the clamp, the construction component can be removed from the clamp.

16. The mounting clamp of claim 15 wherein during placement of the construction component into the clamp, the latch is positioned over the first clamp end and the second clamp end, and the latch is adjusted until it engages with the catch to thereby generally close the clamp.

17. A mounting clamp comprising:
means for maintaining a portion of a construction component in position on a surface;
means for clamping the portion of the construction component within the means for maintaining a portion of a construction component in position on a surface;
means for keeping a clamp substantially closed wherein the clamp is included in the means for maintaining a portion of the construction component in position on a surface wherein the means for keeping a clamp substantially closed does not require one of either the use of any threaded fastener or removal of any part of the means for keeping the clamp substantially closed to be able to position a portion of the construction component within the clamp.

18. The mounting clamp of claim 17 wherein the means for clamping the portion of the construction component within the means for maintaining a portion of the construction component in position on a surface includes a mounting base having the ability to engagingly mount the mounting clamp on a mounting channel.

19. The mounting clamp of claim 18 wherein the means for clamping the portion of the construction component within the means for maintaining a portion of the construction component in position on a surface includes making the mounting clamp from a flexible material.

20. The mounting clamp of claim 18 wherein the flexible material is selected from the group consisting of any plastic-based material and polyvinyl chloride and the wherein means for clamping the portion of construction component and the mounting base are made as a substantially single integrated component.
